(19) United States
(12) Patent Application Publication
(10) Pub. No.: US 2014/0043361 A1
(43) Pub. Date: Feb. 13, 2014

(54) INFORMATION PROCESSING APPARATUS, PROJECTING APPARATUS, INFORMATION PROCESSING METHOD, AND PROJECTING METHOD

(71) Applicant: Shinya MUKASA, Shizuoka (JP)

(72) Inventor: Shinya MUKASA, Shizuoka (JP)

(73) Assignee: RICOH COMPANY, LTD., Tokyo (JP)

(21) Appl. No.: 13/955,143

(22) Filed: Jul. 31, 2013

(30) Foreign Application Priority Data
Aug. 13, 2012 (JP) 2012-179562

(51) Int. Cl. G09G 5/395

(52) U.S. Cl. CPC G09G 5/395
USPC 345/625

(57) ABSTRACT

An image processing apparatus is connected to a projector and sends image data to the projector. The image processing apparatus includes an capturing unit that captures a display screen, a storing unit that stores image data of the captured display screen, a difference image generator that generates difference image data by clipping difference between the image data of the captured display screen and image data of a display screen captured previously, a transfer method determining unit that selects either the difference image data or the image data of the display screen as image data to be sent to the projector, and an image transfer unit that transfers the image data to the projector.

### CROSS-REFERENCE TO RELATED APPLICATION

This patent application is based on and claims priority pursuant to 35 U.S.C. §119 to Japanese Patent Application No. 2012-179562, filed on Aug. 13, 2012 in the Japan Patent Office, the entire disclosure of which is hereby incorporated by reference herein.

### BACKGROUND

1. Technical Field

The present invention relates to an image processing apparatus, an image processing method, image projecting apparatus, and image projecting system.

2. BACKGROUND ART

Conventionally, in environments where a personal computer (PC) is connected a projector via a network, a technology that captures a desktop screen of the PC periodically, sends it as image data to the projector, and projects the image data by using the projector is well known. Also, a technology that reduces network load by sending image data only of areas that have changed (difference image data) to the projector is well known. By reducing network load, the amount of image data (number of frames) that the projector can receive in a given period of time increases, and that results in improving projection frame rate.

Usually, in building software that sends a desktop screen to the projector from the PC via a network, a method that installs a virtual display driver in the PC and has an operating system (OS) notify a user of a change of the desktop screen is well known. However, this method cannot be used in the case of install-less versions that do not install the virtual display driver in the PC due to demand or user-friendly software.

Contrarily, a method that captures the whole desktop screen, compares it with image data of the desktop screen captured previously for each pixel, clips an area that includes all changed pixels (hereinafter referred to as “difference pixels”) only, generates difference image data, and send it to the projector is well known. In this method, the projector updates only the difference areas by superimposing the received difference image data on image data projected previously.

### SUMMARY

The present invention provides a novel image processing apparatus that is connected to a projector and sends image data to the projector.

More specifically, the present invention provides an image processing apparatus that includes a capturing unit that captures a display screen, a storing unit that stores image data of the captured display screen, a difference image generator that generates difference image data by clipping a difference between the image data of the captured display screen and image data of a display screen captured previously, a transfer method determining unit that selects either the difference image data or the image data of the display screen as image data to be sent to the projector, and an image transfer unit that transfers the image data to the projector. The transfer method determining unit determines the transfer method based on either amount of the difference image data or time required to transfer the difference image data to the projector.

FIG. 9 is a diagram illustrating the difference image data received by the projector, the image data previously projected by the projector stored in the storing unit, and the superimposed image that composites former two images. That is, FIG. 9A is a diagram illustrating the projected image data previously received by the projector, FIG. 9B is a diagram illustrating the difference image data sent from the PC, and FIG. 9C is a diagram illustrating the projection image data superimposing the difference image data sent from the PC on the image data previously projected by the projector.

In the conventional technology that sends the difference image data to the projector and projects it, in the event that the difference image data is small, the frame rate is improved since it does not take much time to extract the difference image data and the network traffic is reduced. However, if the difference image data amount is large, not only is the network traffic reduced compared to sending the image data of the PC desktop screen as is, but also the frame rate is degraded contrary since it takes much time to extract the difference image data, and that is a problem.

Especially, if moving image is displayed on the PC desktop screen, the frame rate tends to deteriorate since much difference is generated and amount of the difference image data is kept large.

An image transfer system as another system that transfers image data to the projector has been proposed (e.g., JP-2005-257948-A.) In this image transfer system, a layer sent to the projector is separated from a layer that is not sent to the projector. The image transfer system captures the layer sent to the projector, and the captured layer is sent to the projector. Concurrently, the projector receives the layer sent from the PC and projects the received layer on a screen. That is, the PC separates the layer not displayed on the projector and reduces the network traffic by not having the projector project the unnecessary desktop screen.

However, in the image transfer system above, if the amount of difference image data is large, the frame rate is still degraded even though network traffic is not so reduced, and it takes time to extract the difference image data.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a diagram illustrating an image processing system as an embodiment of the present invention.

FIG. 2 is a block diagram illustrating a hardware configuration of a personal computer (PC) as an embodiment of the present invention.

FIG. 3 is a block diagram illustrating a hardware configuration of a projector as an embodiment of the present invention.

FIGS. 4A and 4B are block diagrams illustrating a functional configuration of the PC and the projector as an embodiment of the present invention.

FIG. 5 is a flowchart illustrating a process of sending image data in the PC as an embodiment of the present invention.

FIG. 6 is a flowchart illustrating a process executed by a transfer method determining unit in the PC as an embodiment of the present invention.

FIG. 7 is a flowchart illustrating a process executed by the projector as an embodiment of the present invention.

FIG. 8 is a diagram illustrating each piece of image data when generating difference image data extracting difference pixel in the PC as an embodiment of the present invention.

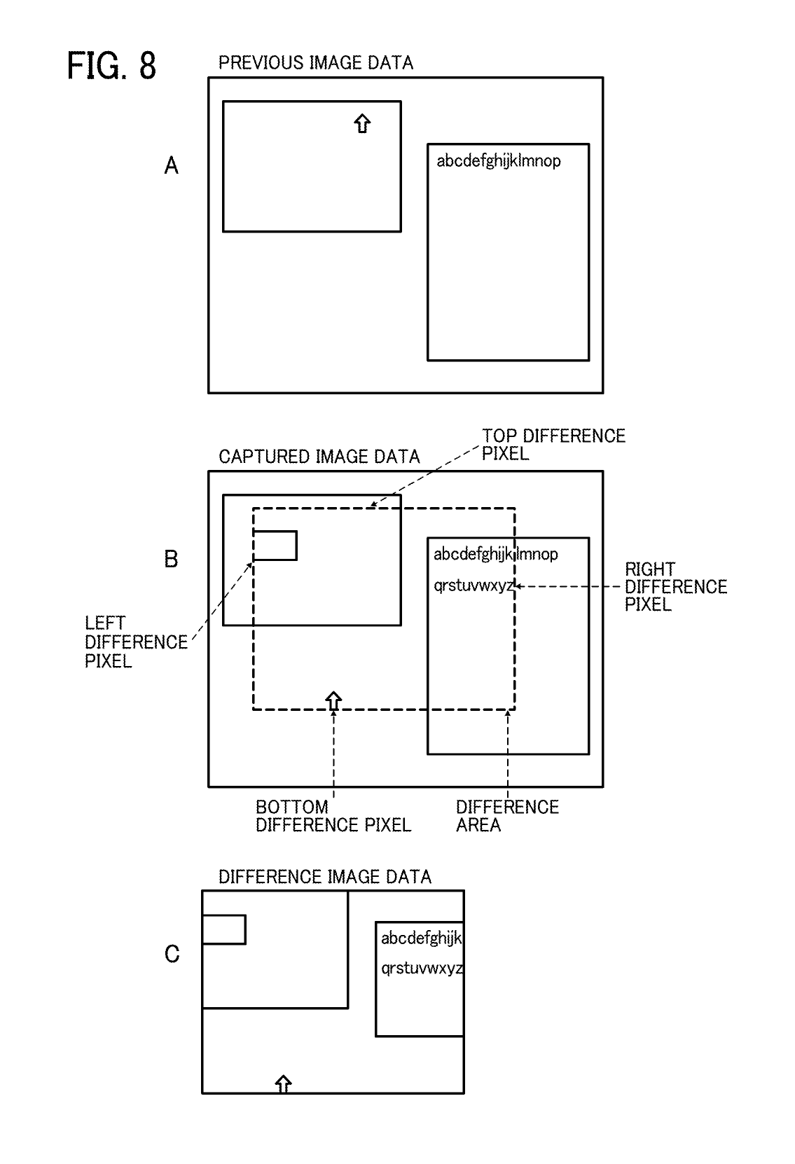

FIG. 9 is a diagram illustrating image data projected previously, the difference image data received by the projector, and superimposed projection image data in the conventional art.

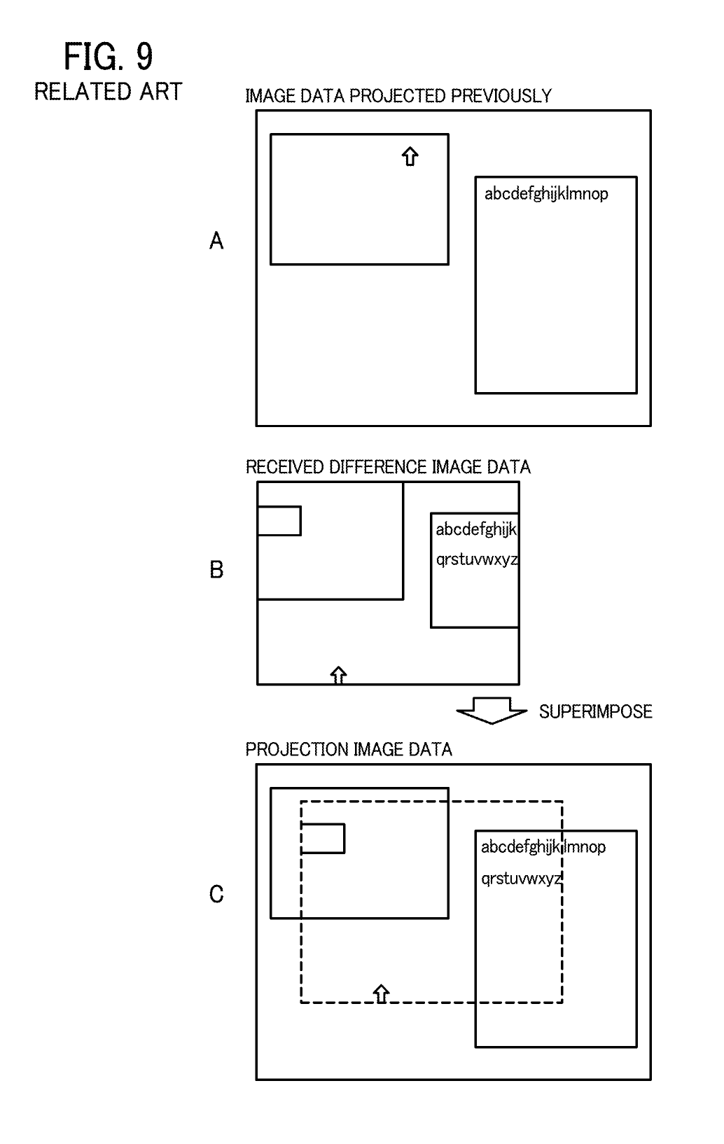

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

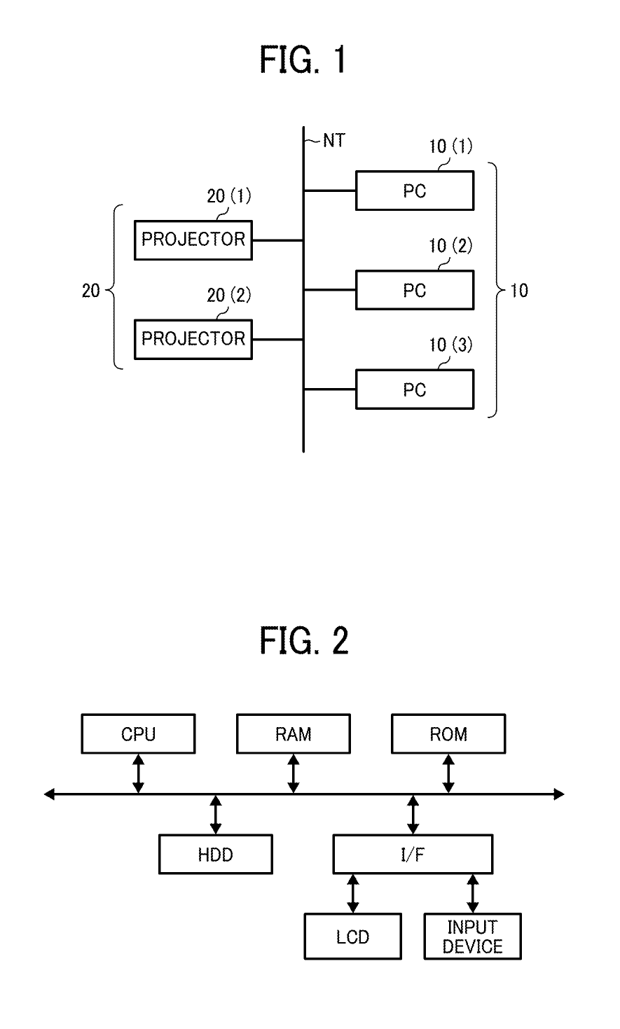

FIG. 1 is a diagram illustrating an image processing system that a PC 10 is connected to a projector 20 via a network NT. In this embodiment, multiple PCs 10 (1), (2), and (3) are connected to multiple projectors 20 (1), (2), and (3) via the network NT.

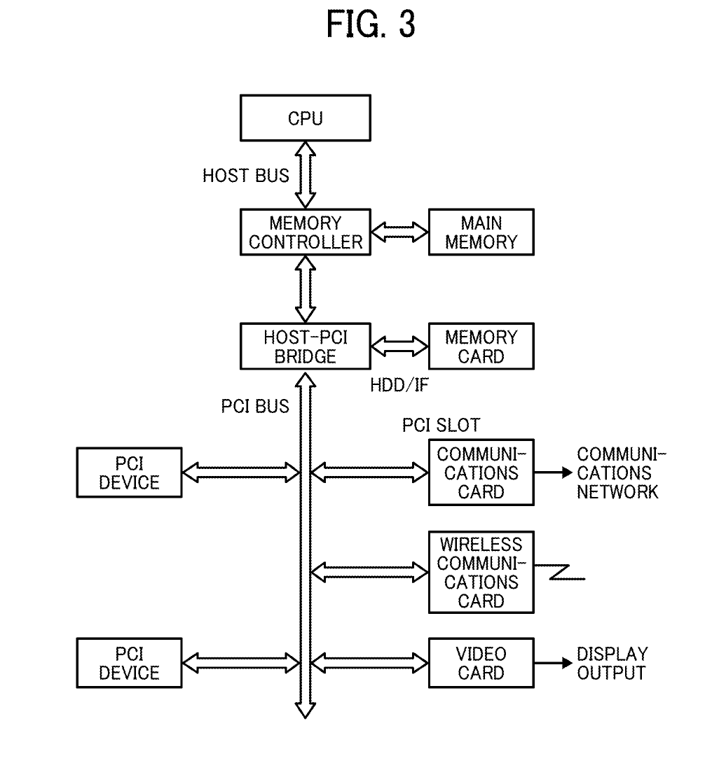

FIG. 2 is a block diagram illustrating a hardware configuration of the PC 10. In this embodiment, the PC 10 has the same configuration as generic information processing terminals. That is, in the PC 10 of this embodiment, a Central Processing Unit (CPU), a Random Access Memory (RAM), a Read Only Memory (ROM), a Hard Disk Drive (HDD), and an interface (UF) are connected with each other via a bus. Also, a Liquid Crystal Display (LCD) and an input device is connected to the UF. The CPU is a processing unit and controls operation of the whole PC 10. The RAM is a high-speed volatile storage device that can read and write data and is used as a work area when the CPU processes data. The ROM is a read-only nonvolatile storage device and stores programs such as firmware. The HDD is a nonvolatile storage device that can read and write data and stores an Operating System (OS), various control programs, and application programs etc. The OF connects the bus with various hardware and the network etc. and controls them. The LCD is a visual user interface that a user can check status of the PC 10. The input device is a user interface such as a keyboard and a mouse that a user can use to input information into the PC 10.

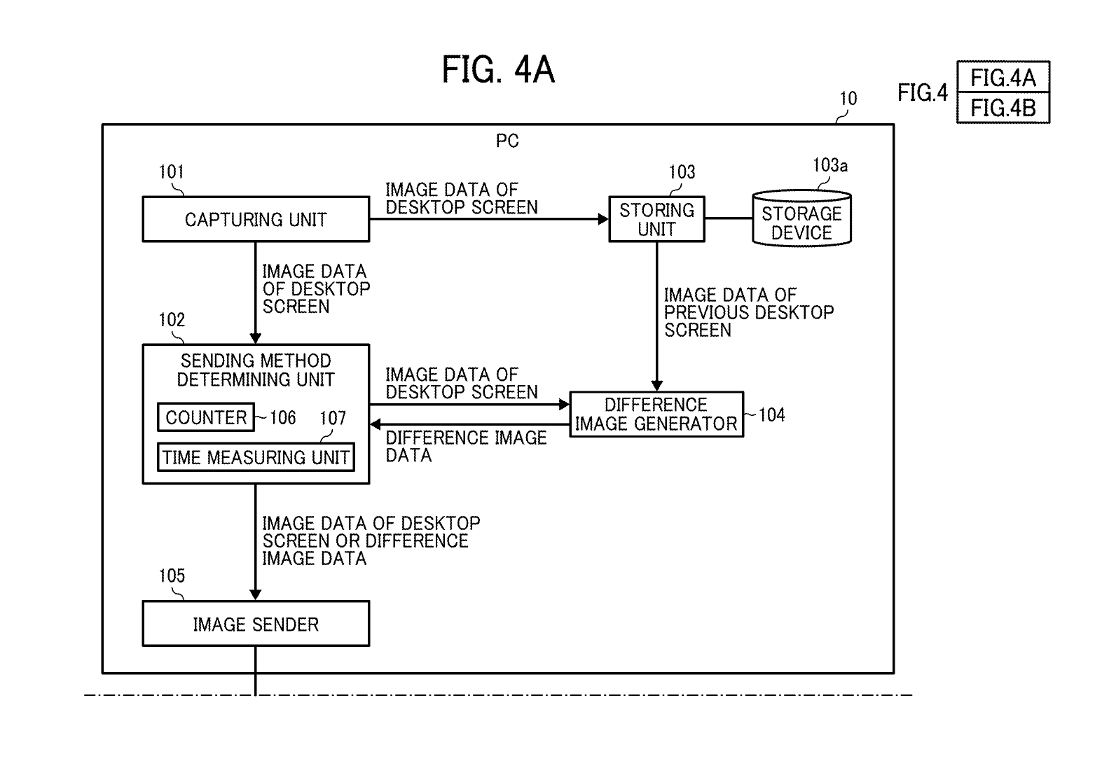

FIG. 3 is a block diagram illustrating a hardware configuration of the projector 20. The projector 20 includes the CPU, a memory controller, a main memory, and a host-PCI bridge. The memory controller is connected to the CPU, the main memory, and the host-PCI bridge via a host bus. The CPU controls the whole projector 20. The main controller controls reading data from the main memory and writing data to the main memory etc. The main memory is a system memory that stores programs and data, executes programs, and processes data, and is used as a video memory. The host-PCI bridge connects peripheral devices and PCI devices. The host-PCI bridge is connected to a memory card via a HDD UF. Also, the host-PCI bridge is connected to a PCI device via PCI bus. Also, the host-PCI bridge is connected to a communications card, a wireless communications card, and a video card etc. via a PCI bus and PCI slots. The memory card is used as a boot device for the OS. The communications card and the wireless communications card are used for connections with a network such as LAN and communications line. The video card is used for projecting an image and outputs a video signal to a display output connector. In this embodiment, control programs executed on the projector 20 are installed in a storage memory area etc. in the main memory preliminarily.

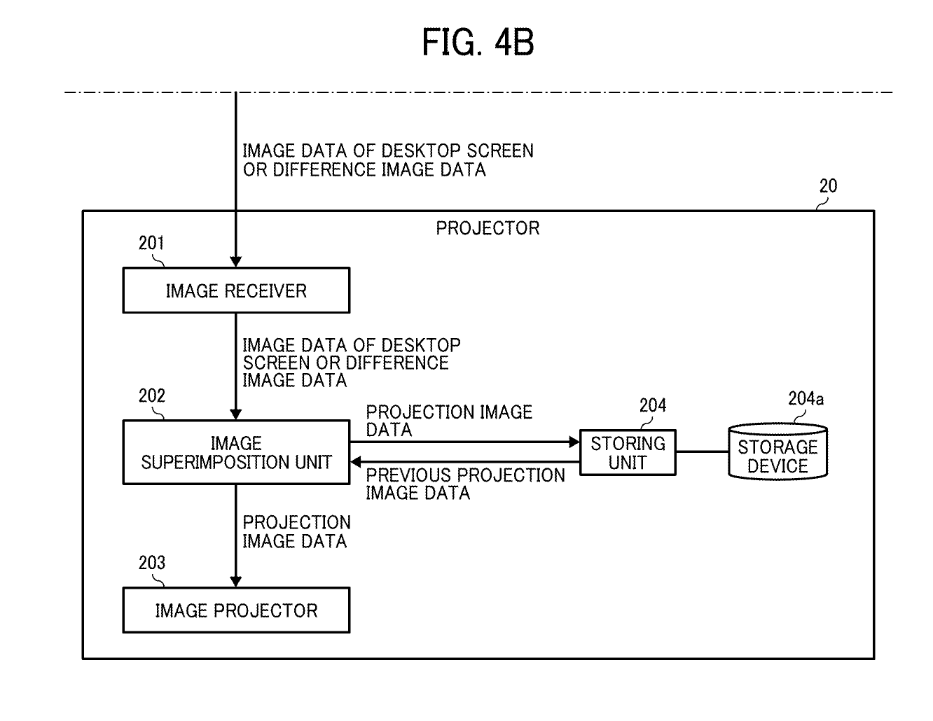

FIGS. 4A and 4B are block diagrams illustrating a functional configuration of the PC 10 and the projector 20. The PC 10 includes a capturing unit 101 that acquires image data of a desktop screen on the PC 10 (that can be either whole image data or image data of a partial image in case of designating the partial image to be displayed), a transfer method determining unit 102 that determines to transfer either as image data of the desktop screen or as difference image data, a storing unit 103 that controls a storage device 103a that stores the image data of the desktop screen, a difference image generator 104 that clips difference from the image data of the previous desktop screen and generates the difference image data, and an image transfer unit 105 that transfers the image data to the projector 20. Units that comprise these functional blocks are function implementing units in the PC 10 based on a program stored in a computer-readable storage medium.

Here, the transfer method determining unit 102 includes a counter 106 that counts the number of times the difference image data is transferred if the difference image data amount or transfer time of the difference image data is more than a predefined value, and an arbitrary time measuring unit 107 that measures time elapsed after changing transfer of the difference image data to transfer of image data of the desktop screen and utilizes internal clock etc. The projector 20 includes an image receiver 201 that receives the image data from the PC 10, an image superimposition unit 202 that superimposes the received image data on projection image data projected previously, an image projecting unit 203 that projects the image data, a storage device 204a that stores the projected image data, and a storing unit 204 that controls the storage device 204a.

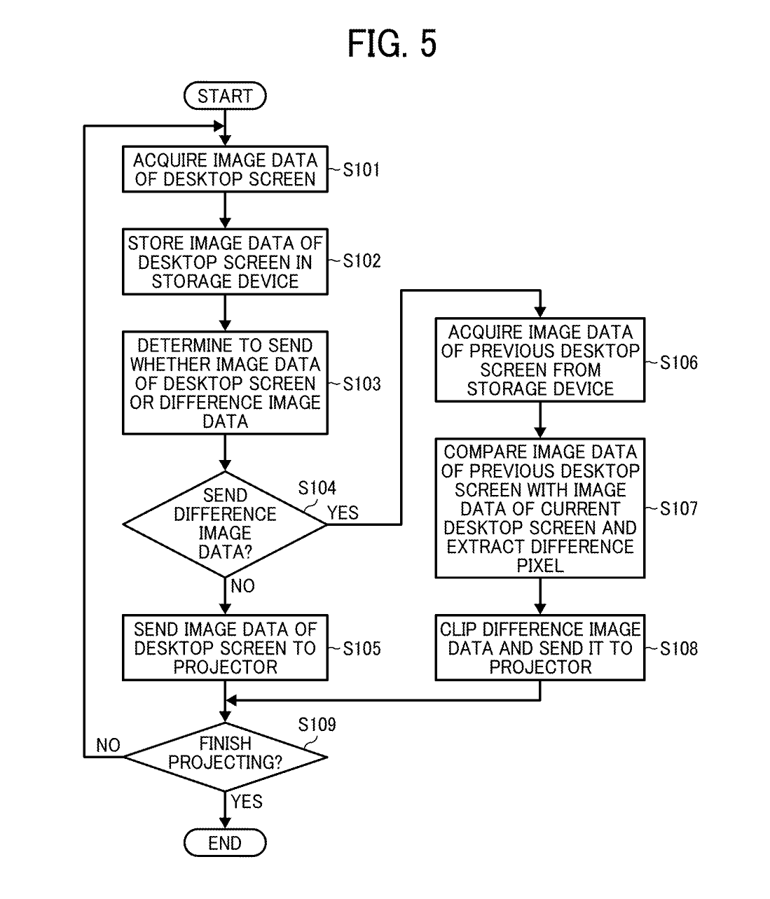

Next, a transfer process of image data in the PC 10 configured as described above will be described below. FIG. 5 is a flowchart illustrating a process of sending image data in the PC 10. After starting the process in the PC 10, the capturing unit 101 acquires image data of a desktop screen in the PC 10 (S101). The acquired image data of the desktop screen is stored in the storage device 103a via the storing unit 103 (S102). Subsequently, the transfer method determining unit 102 determines whether to transfer the image data of the desktop screen to the projector 20 or to transfer the difference image data to the projector 20 with reference to amount of the difference image data or time required to transfer the difference image data to the projector and performs switching (S103).

After performing switching in S103, if the image data of the desktop screen is to be transferred (NO in S104), the image transfer unit 105 transfers the acquired image data of the desktop screen as is to the projector 20 (S105).

After performing switching in S103, if the difference image data is to be transferred (YES in S104), the difference image generator 104 acquires the image data of the previous desktop screen from the storage device 103a via the storing unit 103 to include all extracted difference pixels (S106), compares the image data of the previous desktop screen with the image data of the current desktop screen for each pixel, extracts difference pixels (S107), and generates the difference image data. The image transfer unit 105 transfers the generated difference image data to the projector 20 (S108). Steps from S101 to S108 are repeated until the projector 20 finishes projecting (YES in S109).

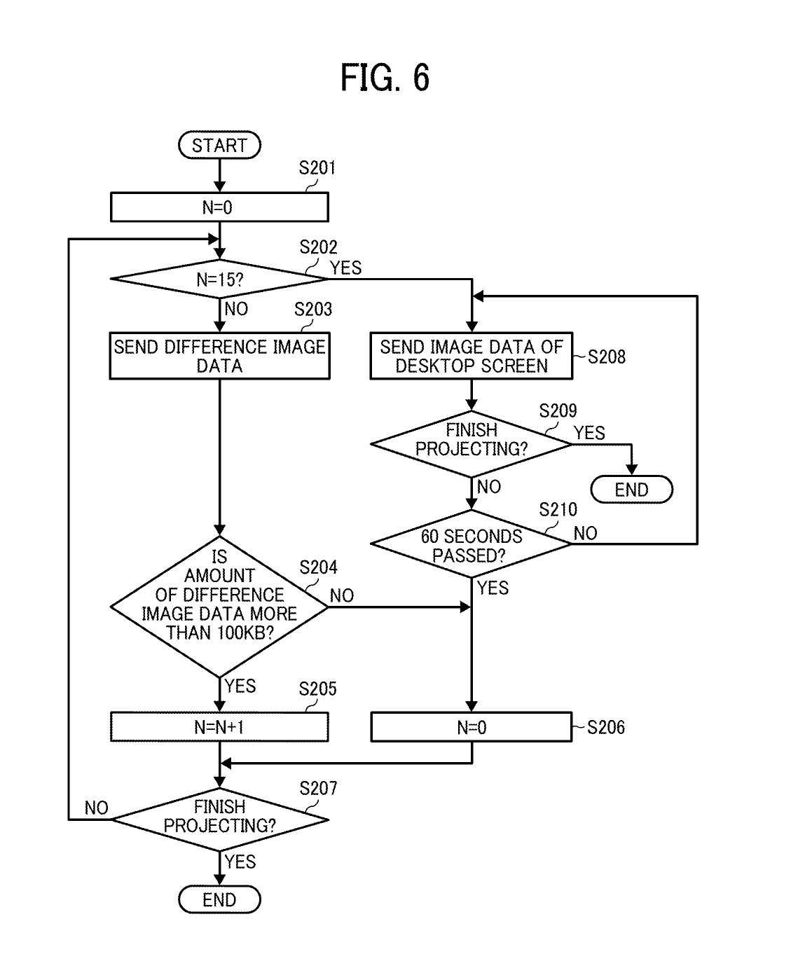

Next, a process executed by the transfer method determining unit 102 in the PC 10 will be described below. FIG. 6 is a flowchart illustrating a process of the transfer method determining unit 102 in the PC 10. In starting the process, the counter counts a number of times N that amount of the difference image data exceeds a predefined value, e.g., more than 100K Bytes, and the counter value is set to 0 firstly (S201). Until N becomes a predefined value, e.g., 15 (NO in S202), the difference image data is transferred (S203). In that case, if amount of the difference image data to be transferred exceeds a predefined value, e.g., more than 100K Bytes (YES in S204), N is incremented (S205). If amount of the difference image data transferred in S204 is less than 100K Bytes (NO in S204), the counter value is reset each time, and N is initialized to 0 (S206). If it is determined that N reaches the predefined value, e.g., 15 (YES in S202), there is a switch to transferring the image data of the desktop screen instead, and the image data of the desktop screen is transferred (S208). If it has finished projecting (YES in S209), the process ends. If it has not finished projecting yet (NO in S209), it keeps transferring the image data of the desktop screen (from S208 to S210) until a predefined time is reached, e.g., 60 seconds (NO in S210).

If 60 seconds have elapsed in S210 (YES in S210), N is initialized to 0 (S206). In this case, if it has not finished projecting yet (NO in S207), the process returns to S520, and there is a switch to transferring the difference image data again, and the difference image data is transferred. The steps from S202 to S210 are repeated until projecting is finished.

As described above, in this embodiment, if the amount of the difference image data exceeds 100K bytes repeats 15 times, the transfer method determining unit 102 changes to transfer the image data of the desktop screen and changes to transfer the difference image data again 60 seconds after starting transferring the image data of the desktop screen unless it has already finished projecting.

These parameters, such as the predefined amount of difference image data (threshold value : 100K bytes in this embodiment), the number of repeating (15), and the predefined (elapsed) time to start transferring the difference image data again after starting transferring the image data of the desktop screen (60 seconds) can be set arbitrarily via an input device (not shown in figures) such as a keyboard. Moreover, these threshold values can be adjusted in accordance with use environment.

Also, assuming 30 ms for generating the difference image data, 30 ms for transferring the 150K-byte difference image data to the projector 20, 20 ms for transferring the 100K-byte difference image data to the projector 20, 10 ms for transferring the 50K-byte difference image data to the projector 20, and 50 ms for transferring the image data of the desktop screen to the projector 20, time to generate the image data to be transferred and finish transferring to the projector 20 becomes as shown in Table 1 below.

TABLE 1

| | Time required to | | |
|---|---|---|---|
| Image data to be | generate difference | | |
| transferred | image data | Transfer time | Total time |
| 150K-byte | 30 ms | 30 ms | 60 ms |
| Difference image | | | |
| data | | | |
| 100K-byte | 30 ms | 20 ms | 50 ms |
| Difference image | | | |
| data | | | |
| 50K-byte Difference | 30 ms | 10 ms | 40 ms |
| image data | | | |
| Image data of | 0 ms | 50 ms | 50 ms |
| desktop screen | | | |

As shown in Table 1, if the difference image data amount is less than 100K bytes, total time is shortened by transferring the image data of the desktop screen.

Also, in the description above, there is a switch to transferring the image data of the desktop screen depending on amount of the difference image data. In addition, it is possible to switch depending on transmission rate to transfer the difference image data to the projector 20 (it can be transfer time, and hereinafter referred to as “transfer time”). In that case, if the transfer time of the difference image data exceeds a predefined time, e.g., more than 20 ms repeats 15 times, there is a switch to transferring the image data of the desktop screen.

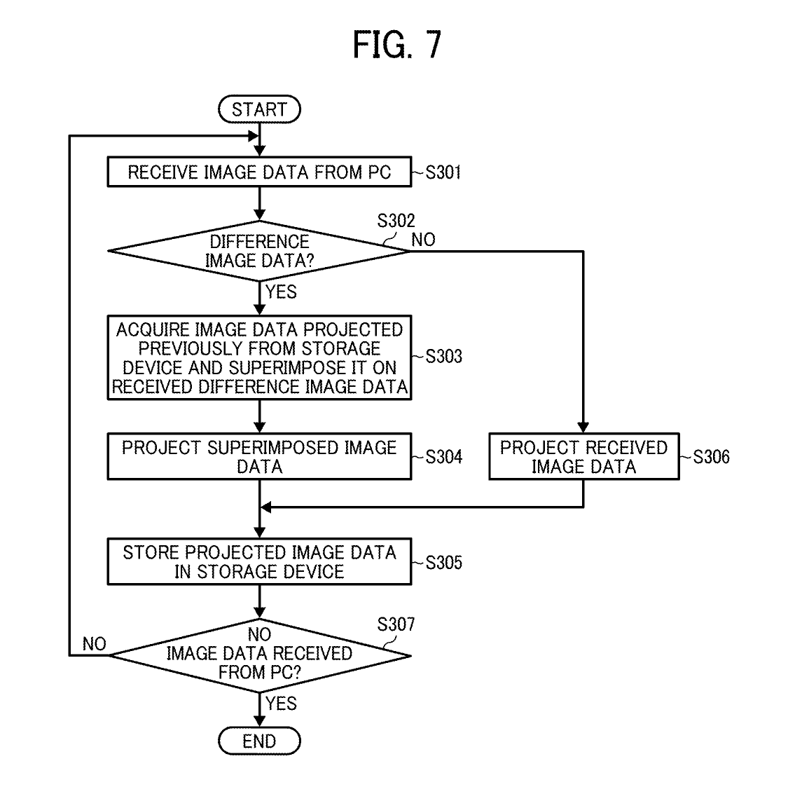

Next, a process that the projector 20 executes will be described below. FIG. 7 is a flowchart illustrating a process executed by the projector 20. First, the image receiver 201 receives image data from the PC 10 (S301). If the difference image data is received (YES in

S302), the image superimposition unit 202 acquires the image data projected previously from the storage device 204a via the storing unit 204 and superimposes it on the difference image data received from the PC 10 (S303). The projector 20 projects the superimposed image data using the image projector 203 (S304) and stores it in the storage device 204a via the storing unit 204.

If the difference image data is not received in S302, that is, the image data of the desktop screen of the PC 10 is received (NO in S302), the projector 20 projects the image data received from the PC 10 as is (S306) and stores it in the storage device 204a via the storing unit 204 (S305).

If there is no image data transferred from the PC 10 (YES in S307), the process ends. If the image data is transferred from the PC 10 (NO in S307), the steps from S301 to S307 are repeated. That is, the steps from S301 to S307 repeat until there is no more image data from the PC 10.

In the environment where the PC 10 and the projector 20 are connected electrically, i.e., connected with each other via the network NT, in case the projector 20 projects the image data of the desktop screen of the PC 10, the transferred image data can be changed into either the difference image data between the previous image data of the desktop screen and the current image data of the desktop screen (the captured image data) or the image data of the desktop screen of the PC 10.

That is, if the desktop screen changes slightly such as mouse operation, the transfer method determining unit 102 transfers the difference image data of the desktop screen to the projector 20. If the desktop screen changes largely such as playing a moving image, the transfer method determining unit 102 changes to transfer not the difference image data but the image data of the desktop screen for a predefined time. Subsequently, after a predefined time (60 seconds) has elapsed, the transfer method determining unit 102 changes to transfer the difference image data to the projector 20. That is, the transferred image data is changed depending on the time required to extract difference pixels and generate the difference image data and the increase of transfer time due to increase of amount of transferred image data (i.e., the increase of burden to transfer the image data), and it is possible to transfer the image data at effective frame rate constantly.

The present invention realizes appropriate frame rate by changing image data to be sent to the difference image data of displaying screen or image data of displaying screen based on the amount of the difference image data or transfer time of the difference image data to the projector in processing an image to be sent to the projector.

While the case that the desktop screen of the PC is transferred to the projector is described above, the present invention is not limited to that, and a mobile or an immobile image processing apparatus can be used instead of the PC. In that case, the screen is the display screen of the image processing apparatus.

Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. An information processing apparatus that is connected to a projecting apparatus and sends image data to the projecting apparatus, comprising:
a capturing unit to capture a display screen;
a storing unit to store image data of the captured display screen;
a difference image generator to generate difference image data by clipping a difference between the image data of the captured display screen and image data of a display screen captured previously;
a transfer method determining unit to select either the difference image data or the image data of the display screen as sending image data to be sent to the projecting apparatus; and
an image transfer unit to transfer the sending image data to the projecting apparatus,
wherein the transfer method determining unit selects the transfer method based on either an amount of the difference image data or a time required to transfer the difference image data to the projecting apparatus.

2. The information processing apparatus according to claim 1, wherein the transfer method determining unit comprises a counter that counts the number of times the difference image data is transferred if the difference image data amount or transfer time of the difference image data is more than a predefined value, and changes from transferring the difference image data into transferring the image data of the display screen in case the counter reaches at predefined count value.

3. The information processing apparatus according to claim 2, wherein the transfer method determining unit comprises a time measuring unit that measures time elapsed after changing transfer of the difference image data to transfer of image data of the desktop screen, and changes from transferring the difference image data to transferring the image data of the display screen in case the time measuring unit reaches a predefined time.

4. The information processing apparatus according to claim 3, further comprises an input device that sets the predefined amount of the difference image data, the predefined count value, the predefined time to transfer the difference image data, and the predefined time elapsed after changing from transferring the difference image data into transferring the image data of the display screen

5. The information processing apparatus according to claim 2, wherein the counter in the transfer method determining unit is reset in case the amount of the transferred difference image data is less than the predefined value.

6. A projecting apparatus that projects image data transferred from an information processing apparatus, comprising:
an image receiver to receive image data from the information processing apparatus;
a storing unit to store the projected image data;
an image superimposition unit to generate projection image data from image data projected previously and difference image data if the difference image data generated by clipping difference between the image data of the captured display screen and image data of a display screen captured previously is received; and
an image projecting unit to project the projection image data generated by the image superimposition unit.

7. A method of controlling an information processing apparatus that is connected to a projecting apparatus and sends image data to the projecting apparatus, comprising the steps of:
capturing a display screen;
storing image data of the captured display screen;
generating difference image data by clipping a difference between the image data of the captured display screen and image data of a display screen captured previously;
selecting either the difference image data or the image data of the display screen as image data to be sent to the projecting apparatus; and
transferring the image data to the projecting apparatus,
wherein the step of selecting is executed based on either an amount of the difference image data or a time required to transfer the difference image data to the projecting apparatus.

8. A method of controlling a projecting apparatus that projects image data transferred from an information processing apparatus, comprising the steps of:
receiving image data from the information processing apparatus;
storing the projected image data;
generating projection image data from image data projected previously and difference image data if the difference image data generated by clipping a difference between the image data of the captured display screen and image data of a display screen captured previously is received; and
projecting the projection image data generated in the projection image data generating step.
